(19) United States
(12) Patent Application Publication
(10) Pub. No.: US 2019/0248057 A1
(43) Pub. Date: Aug. 15, 2019

(54) ELONGATED FLUOROELASTOMERIC ARTICLES AND METHODS OF MAKING THE SAME

(71) Applicant: 3M INNOVATIVE PROPERTIES COMPANY, St. Paul, MN (US)

(72) Inventors: Michael H. Mitchell, Woodbury, MN (US); Tatsuo Fukushi, Woodbury, MN (US); Karen L. Hopperstad, Cottage Grove, MN (US); Jarod R. Lowry, Eagan, MN (US); Peter J. Scott, Woodbury, MN (US); Nena M. Serios, Hudson, WI (US)

(21) Appl. No.: 16/260,172

(22) Filed: Jan. 29, 2019

Related U.S. Application Data
(60) Provisional application No. 62/628,442, filed on Feb. 9, 2018.

(51) Int. Cl. B29C 48/154; B29C 48/00; B29C 48/03; B29C 48/91; C08F 14/22; C08F 14/26; C08F 14/28; C08K 5/14; F04C 2/107; F04C 15/00

(52) U.S. Cl. CPC B29C 48/154; B29C 48/0021; B29C 48/022; B29C 48/03; B29C 48/91; B29K 2027/16; C08F 14/26; C08F 14/28; C08K 5/14; F04C 2/1075; F04C 15/003; C08F 14/22

(57) ABSTRACT

Described herein is method of making elongated fluoroelastomeric articles using a millable composition comprising (a) a random fluorinated polymer, the random fluorinated polymer comprising repeating divalent monomeric units derived from TFE, HFP and VDF and further comprising 0.1 to 1% by weight iodine, wherein the random fluorinated polymer has an MFI greater than 5 g/10 min at 265° C. and 5 kg; (b) a filler, and (c) a peroxide, wherein the millable composition has a melting point less than 125° C. Such compositions can be used to make elongated articles such as stators.

### CROSS REFERENCE TO RELATED APPLICATIONS

This application claims priority from U.S. Provisional Application Ser. No. 62/628,442, filed Feb. 9, 2018, the disclosure of which is incorporated by reference in its/their entirety herein.

### TECHNICAL FIELD

Discussed herein is a fluoropolymeric composition whose properties enable the fluoropolymeric composition to be compound and molded into elongated parts such as stators.

### BACKGROUND

A progressing cavity pump includes a rotor and a stator having an inlet and an outlet. The rotor is rotationally disposed inside of the stator such that rotation of the rotor causes fluid in the pump to be pumped from the inlet toward the outlet in a downstream direction. Such pumps find use in the transfer of fluids from the inlet to the outlet in applications in the food, pharmaceutical, and oil and well drilling.

### SUMMARY

There is a desire to identify a fluorinated polymeric material, which could be used for stator applications. This fluorinated polymeric material should be elastic in nature, able to be extruded to an elongated length, and provide good durability. In one embodiment, the fluorinated polymeric material comprises little to no processing aide.

In one aspect, a method of making an assembly is described, the method comprising:
obtaining a millable composition comprising (a) a random fluorinated polymer, the random fluorinated polymer comprising repeating divalent monomeric units derived from TFE, HFP and VDF and further comprising 0.1 to 1% by weight iodine, wherein the random fluorinated polymer has an MFI greater than 5 g/10 min at 265° C. and 5 kg; (b) a filler, and (c) a peroxide, wherein the millable composition has a melting point less than 125° C.;
obtaining a casing open at both ends and positioning a mandrel running longitudinally therethrough;
extruding the millable composition into a space between an interior wall of the casing and the mandrel to form a shaped composition;
treating the shaped composition with heat to bond the shaped composition to the interior wall of the casing to form an assembly.

In one aspect, an article is described comprising: a shaped fluorinated polymer derived from (a) a fluorinated elastomeric gum comprising repeating divalent monomeric units, the repeating divalent monomeric units derived from TFE, HFP and VDF and comprising 0.1 to 1% by weight iodine, (b) a filler, and (c) a peroxide, wherein the fluorinated elastomeric gum has an MFI greater than 5 g/10 min at 265° C. and 5 kg; and wherein the shaped fluorinated elastomeric polymer is elongated and includes an open core with lobes.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

Other features and advantages of the method and article disclosed herein will be clear from reading the description hereafter of embodiments given by way of non-limitative example, with reference to the accompanying drawings, wherein

FIG. 1 shows the general structure of a progressive-cavity pump comprising a rotor and a stator.

FIG. 2 shows various configurations for the geometry of a progressive-cavity pump;

FIG. 3 shows an example of a mold for manufacture; and

FIG. 4 shows an exemplary stator.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer; and

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

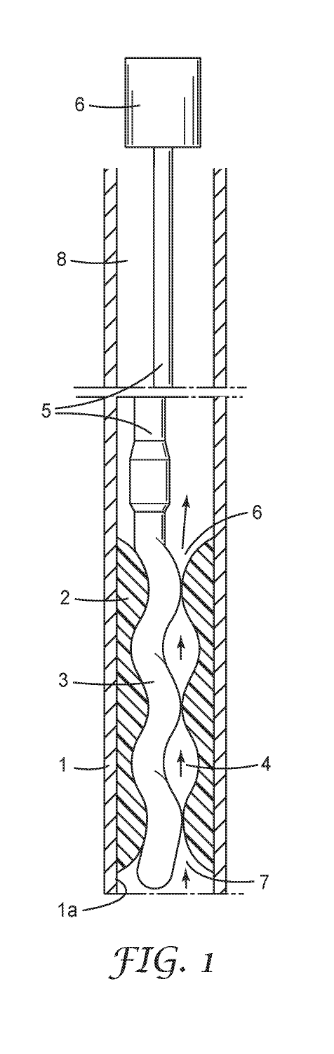

FIG. 1 shows a general layout of a Moyno style progressive cavity pump. The pump comprises casing 1, wherein the effluent to be pumped circulates. This pump barrel notably contains: stator 2 in contact with the inner wall 1a of the casing, rotor 3 placed inside the stator, the shape of the stator and the shape of the rotor, as well as the dimensions thereof, are such that the rotation of the rotor in the stator generates closed cavities 4 that move along the rotor. This motion allows the pumping function to be fulfilled, element 5 connecting the rotor to device 6 for driving it in rotation, arranged outside the casing for example, provides the rotating motion. Element 5 is selected to compensate for the difference in the nature of the motion between driving device 6 and the epicycloidal motion of rotor 3. This element can be a flexible device or a Cardan link. Casing 1 is provided with at least one opening 7 for delivery of the fluid to be pumped, and with a passage or opening 8 for discharge of the fluid.

Typically, the stator is a male configuration comprising lobes which can form fluid-filled cavities as the lobes of the rotor and stator interact. Generally, the number of lobes between the rotor and the stator differ by one. Shown in FIG. 2 are cross-sections of various progressive cavity pumps comprising casing 21, stator 22, and rotor 23. As shown in FIG. 2A, the rotor comprises 1 lobe (23) and the stator comprises 2 lobes (28A and 28B), wherein rotor 23 is engaged with lobe 28B. As shown in FIG. 2B, the rotor comprises 3 lobes and the stator comprises 4 lobes. As shown in FIG. 2C, the rotor comprises 5 lobes and the stator comprises 6 lobes. As shown in FIG. 2D, the rotor comprises 7 lobes and the stator comprises 8 lobes. In order to obtain satisfactory pressure heads, the cavities formed between the rotor and the stator must be closed with a certain sealing level. Sealing is provided by a negative clearance between the diameter of the section of the rotor and the dimension of the stator teeth (or lobes). The stators may be formed from or coated with an elastomeric material, which can ensure a strong seal between the stator and the rotor. Typically, these stators are made by extruding materials such as conventional nitrile (nitrile-butadiene rubber, NBR) elastomers and hydrogenated NBR elastomers.

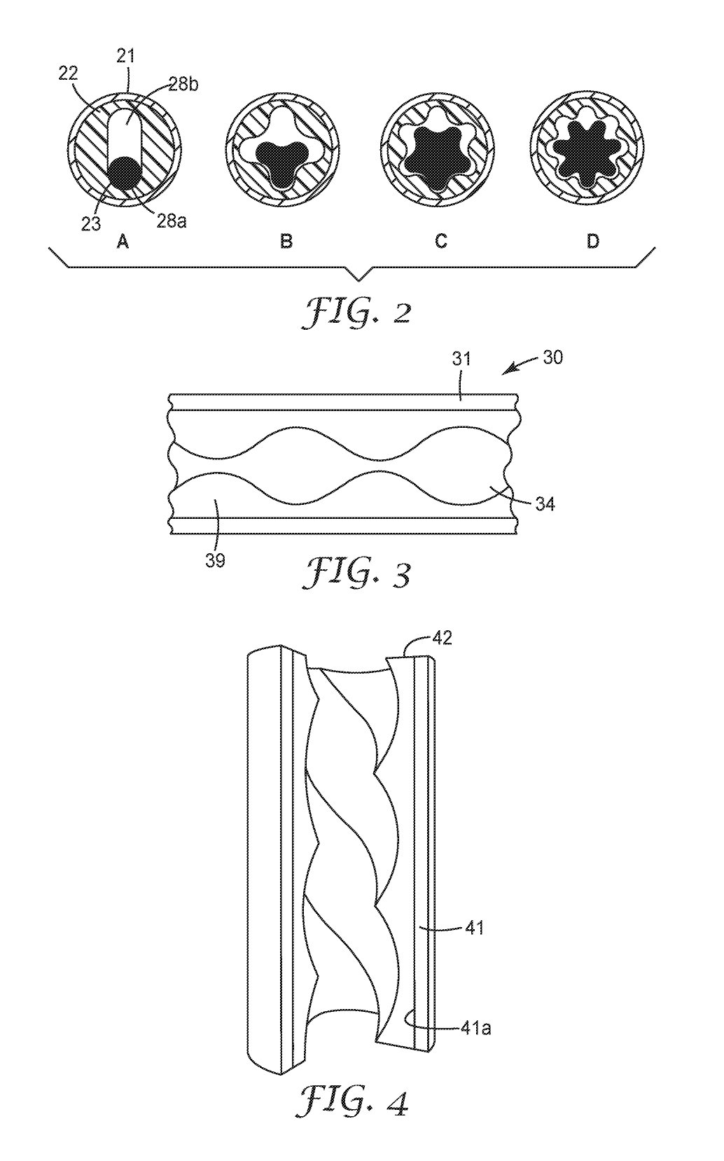

In one-component stators, wherein the stator comprises an elastomeric material within a casing, the stators are typically manufactured by extrusion of a polymeric material into a mold. Such a mold is shown in FIG. 3, wherein mandrel 34 is longitudinally positioned within casing 31. Curable polymeric material is extruded into open space 39. When the molds have extreme lengths, traditionally, the extrusion happens in shots, wherein a given volume of polymeric material is extruded into the mold, followed by another given volume of material, and the process is repeated until the entire length of the mold is filled. In one embodiment, a bonding agent is coated on the interior wall of casing 31. The bonding agent is used to subsequently bond the polymeric material to the casing. Thus, in order to make an elongated article, such as a stator, the curable polymeric material must be able to (a) be extruded at reasonable pressures, (b) be sufficiently flowable so that the bonding agent is not scraped away from the casing sidewall as the polymeric material is pushed down the entire length of the mold, and (c) have sufficient mechanical properties (such as durability). Depending on the length of the mold and the volume of the shot, the curable polymeric material must be able to (d) “knit” the various shots of material together so as not to generate a weak point along the length of the article.

Fluorinated polymers are known to have good heat and chemical resistance due to the presence of the C—F bonds. Low molecular weight fluoroelastomers are known to have a good flow profile allowing them to be fabricated in long lengths, but these fluoroelastomers lack sufficient durability for stator applications (such as the ability to withstand the constant rubbing of the rotor and/or the abrasion due to solids, such as rocks or particles, that may be present). Increasing the molecular weight of the fluoroelastomer can improve its durability, however, increasing the molecular weight also increases the viscosity, making the polymer difficult to flow. Due to the inferior flow properties of traditional fluoroelastomers, processing aides are added to decrease the viscosity. However, these processing aides can negatively impact bonding and/or the mechanical properties of the fluoroelastomer.

The present disclosure has identified a particular fluorinated polymer, which is able to be processed as an elastomer and have elastomeric characteristics, while also having some crystalline nature, allowing the fluorinated polymer to flow readily and have good mechanical properties without requiring substantial amounts of process aides.

The present application is directed toward a millable composition comprising a fluorinated polymer and wherein curatives and fillers can be compounded into the fluorinated polymer.

The fluorinated polymer of the present disclosure is a random fluorinated copolymer derived from at least the following monomers: tetrafluoroethylene (TFE), hexafluoropropylene (HFP), and vinylidene fluoride (VDF). The random fluorinated copolymers disclosed herein are not block copolymers, meaning that they do not contain at least two different polymeric segments, which may or may not comprise the same monomeric units but at different ratios.

In one embodiment, the fluorinated polymer is derived from at least 20, 25 or even 30 wt % and at most 40, 50, 55, or even 60 wt % TFE; at least 10, 15, or even 20 wt % and at most 25 or even 30 wt % HFP; and at least 15, 20, or even 30 wt % and at most 50, 55, or even 60 wt % VDF. Additional monomers may also be incorporated into the fluorinated polymer, such as those derived from perfluorovinyl ether monomer, perfluoroallyl ether monomers, and cure site monomers. Typically, these additional monomers are used at percentages of less than 10, 5, or even 1% by weight relative to the other monomers used.

Examples of perfluorovinyl ethers that can be used in the present disclosure include those that correspond to the formula: CF₂═CF—O—R_{f} wherein R_{f} represents a perfluorinated aliphatic group that may contain no oxygen atoms or one or more oxygen atoms, and up to 4, 6, 8, 10, or even 12 carbon atoms. Exemplary perfluorinated vinyl ethers correspond to the formula: CF₂═CFO(R^{a}_{f}O)ₙ (R^{b}_{f}O)ₘR^{c}_{f} wherein R^{a}f and R^{b}f are different linear or branched perfluoroalkylene groups of 1-6 carbon atoms, in particular 2-6 carbon atoms, m and n are independently 0-10 and R^{c}_{f} is a perfluoroalkyl group of 1-6 carbon atoms. Specific examples of perfluorinated vinyl ethers include perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CFOCF₂OCF₃, CF₂═CFOCF₂OCF₂CF₃, and CF₃—(CF₂)₂—O—CF(CF₃)—CF₂—O—CF(CF₃)—CF₂—O—CF═CF₂.

Examples of perfluoroallyl ethers that can be used in the present disclosure include those that correspond to the formula: CF₂═CF(CF₂)—O—R_{f} wherein R_{f} represents a perfluorinated aliphatic group that may contain no, one or more oxygen atoms and up to 10, 8, 6 or even 4 carbon atoms. Specific examples of perfluorinated allyl ethers include: CF₂═CF₂—CF₂—O—(CF₂)ₙF wherein n is an integer from 1 to 5, and CF₂═CF₂—CF₂—O—(CF₂)ₓ—O—(CF₂)_{y}—F wherein x is an integer from 2 to 5 and y is an integer from 1 to 5. Specific examples of perfluorinated allyl ethers include perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof.

Examples of cure site monomers include, halogenated cure site monomers such as those of the formula: (a) CX₂═CX(Z), wherein: (i) X each is independently H or F; and (ii) Z is I, Br, R_{f}—U wherein U═I or Br and R_{f}=a perfluorinated alkylene group optionally containing O atoms or (b) Y(CF₂)_{q}Y, wherein: (i) Y is independently selected from Br, I, or Cl and (ii) q=1-6. In addition, non-fluorinated bromo- or iodo-olefins, e.g., vinyl iodide and allyl iodide, can be used. In some embodiments, the cure site monomers are derived from one or more compounds selected from the group consisting of CF₂═CFCF₂I, ICF₂CF₂CF₂CF₂I, CF₂═CFCF₂CF₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CF₂═CFCF₂Br, CF₂═CFOCF₂CF₂Br, CF₂═CFCl, CF₂═CFCF₂Cl, and combinations thereof.

The fluorinated polymer of the present disclosure comprises iodine endgoups (i.e., the polymer has terminal groups that comprise iodine). In one embodiment, the fluorinated polymer comprises at least 0.1, or even 0.5; and at most 0.8, or even 1 wt % iodine end groups based on the weight of the fluorinated polymer. These iodine endgroups are introduced into the polymer during its polymerization through the use of an iodo chain transfer agent, and/or an iodinated cure site monomer.

In one embodiment of the present disclosure, the fluorinated polymer has a glass transition (Tg) temperature of greater than −10° C., −5° C., 0° C., 5° C., 10° C., 15° C., or even 20° C.; and less than 80° C., 70° C., 60° C., or even 50° C. as measured by differential scanning calorimetry (DSC). In one embodiment of the present disclosure, the fluorinated polymer has a single (Tg).

In one embodiment of the present disclosure, the fluorinated polymer has a melting temperature (Tm) of at least 60° C., 70° C., 80° C., or even 100° C.; and at most 320° C., 300° C., 280° C., 250° C., or even 200° C. In one embodiment, the melting point of the fluorinated polymer is less than the upper use temperature of the resulting article.

In one embodiment, the fluorinated polymer has an MFI greater than 5, 5.5, 6, or even 7 g/10 min at 265° C. and 5 kg. Melt Flow Index (MFI) or Melt Flow Rate (MFR) can be used as a measure of the ease of the melt of a fluorinated polymer. As MFI is higher, flow is better. It is also an indirect measurement of molecular weight. As MFI is higher, the molecular weight is lower. Typical MFI measurement settings for temperature and weight depend on the melting point of the polymer. When the melting point of a polymer is higher, the temperature setting of the MFI needs to be higher.

In one embodiment of the present disclosure, the weight average molecular weight of the fluorinated polymer is at least 10,000 dalton, 20,000 dalton, at least 30,000 dalton, or even at least 50,000 dalton; and at most 75,000, at most 100,000 dalton, at most 300,000 dalton, or even at most 500,000 dalton. The fluorinated polymer of the present disclosure, may have a unimodal, bimodal, or multimodal (having more than 2 modes) weight average molecular weight distribution.

The fluorinated polymers of the present disclosure can be prepared by various known methods as long as the iodine is incorporated into the fluorinated polymer.

In one embodiment, the polymer can be prepared by iodine transfer polymerization as described in U.S. Pat. No. 4,158,678 (Tatemoto et al.). Briefly, during an emulsion polymerization, a radical initiator and an iodine chain transfer agent is used to generate a polymer latex. The radical polymerization initiator to be used for preparing the polymer may be the same as the initiators known in the art that are used for polymerization of fluorine-containing elastomer. Examples of such an initiator are organic and inorganic peroxides and azo compounds. Typical examples of the initiator are persulfates, peroxy carbonates, peroxy esters, and the like. In one embodiment, ammonium persulfate (APS) is used, either solely, or in combination with a, reducing agent like suifites. Typically, the iodine chain transfer agent is a diiodine compound used from 0.01 to 1% by weight based on the total weight of the amorphous polymer. Exemplary diiodine compounds include: 1,3-diiodoperfluoropropane, 1,4-diiodoperfluorobutane, 1,3-diiodo-2-chloroperfluoropropane, 1,5-diiodo-2,4-dichloroperflu oropentane, 1,6-diiodoperfluorohexane, 1,8-diiodoperfluorooctane, 1,10-diiodoperfluorodecane, 1,12-diiodoperfluorododecane, 1,16-diiodoperfluorohexadecane, diiodonethane and 1,2-diiodoethane. For the emulsion polymerization, various emulsifying agents can be used. From the viewpoint of inhibiting a chain transfer reaction against the molecules of emulsifying agent which arises during the polymerization, desirable emulsifying agents are salts of carboxylic acid having a fluorocarbon chain or fluoropolyether chain. It is desirable that an amount of emulsifying agent is from about 0.05% by weight to about 2% by weight, or even 0.2 to 1.5% by weight based on the added water. The thus-obtained latex comprises a fluorinated polymer that has an iodine atom at a terminal position.

In one embodiment, the millible composition of the present disclosure is not a blend of polymers. In one embodiment, the fluorinated polymer in the millible composition has a single Tg.

The fluorinated polymer of the present disclosure can be processed similarly to an elastomer, for example during the compounding of an amorphous gum, the amorphous polymer is mixed or blended with the requisite curing agents and other adjuvants using a two-roll mill or an internal mixer. In order to be mill blended, the curable composition must have a sufficient modulus. In other words, not too soft that it sticks to the mill, and not too stiff that it cannot be banded onto mill. Thus, in one embodiment, the fluorinated polymer has a modulus of at least 0.001, 0.005, 0.01, 0.05, 0.1, 0.3, or even 0.5 MPa; and at most 2.0, 2.2, or even 2.5 MPa at 100° C. as measured at a strain of 1% and a frequency of 1 Hz (e.g., from the storage modulus obtained via ASTM 6204-07), enabling the fluorinated polymer to be processed at room or slightly above room temperature.

The millable composition comprises a peroxide curing agent. Peroxide curatives include organic or inorganic peroxides. Organic peroxides are preferred, particularly those that do not decompose during dynamic mixing temperatures.

The crosslinking using a peroxide can be performed generally by using an organic peroxide as a crosslinking agent and, if desired, a crosslinking aid including, for example, bisolefins (such as CH₂═CH(CF₂)₆ CH═CH₂, and CH₂═CH(CF₂)₈ CH═CH₂), diallyl ether of glycerin, triallylphosphoric acid, diallyl adipate, diallylmelamine and triallyl isocyanurate (TAIC), fluorinated TAIC comprising a fluorinated olefinic bond, tri(methyl)allyl isocyanurate (TMAIC), tri(methyl)allyl cyanurate, poly-triallyl isocyanurate (poly-TAIC), xylylene-bis(diallyl isocyanurate) (XBD), and N,N′-m-phenylene bismaleimide.

Examples of the organic peroxide include benzoyl peroxide, dicumyl peroxide, dialkyl peroxide, bis (dialkyl peroxide), 2,5-dimethyl-2,5-di(tertiarybutylperoxy)₃-hexyne, di-tert-butyl peroxide, 2,5-di-methyl-2,5-di-tert-butylperoxyhexane, 2,4-dichlorobenzoyl peroxide, di(2-t-butylperoxyisopropyl)benzene, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, di[1,3-dimethyl-3-(t-butylperoxy)butyl] carbonate, carbonoperoxoic acid, 0,0′-1,3-propanediyl OO,OO′-bis(1,1-dimethylethyl) ester, α,α′-bis(t-butylperoxy-diisopropylbenzene), dibenzoyl peroxide, tert-butylperoxy benzoate, t-hexyl peroxy-2-ethylhexanoate, t-butyl peroxy-2-ethylhexanoate, di(4-methylbenzoyl) peroxide, carbonoperoxoic acid, laurel peroxide and cyclohexanone peroxide. Other suitable peroxide curatives are listed in U.S. Pat. No. 5,225,504 (Tatsu et al.). The amount of peroxide curing agent used generally will be 0.1 to 5, preferably 1 to 3 parts by weight per 100 parts of fluorinated polymer.

Typically, a coagent is used along with the peroxide to improve the cure. Coagents are multifunctional polyunsaturated compound, which are known in the art and include allyl-containing cyanurates, isocyanurates, and phthalates, homopolymers of dienes, and co-polymers of dienes and vinyl aromatics. A wide variety of useful coagents are commercially available including di- and triallyl compounds, divinyl benzene, vinyl toluene, vinyl pyridine, 1,2-cis-polybutadiene and their derivatives. Exemplary coagents include a diallyl ether of glycerin, triallylphosphoric acid, diallyl adipate, diallylmelamine and triallyl isocyanurate (TAIC), tri(methyl)allyl isocyanurate (TMAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Exemplary partially fluorinated compounds comprising two terminal unsaturation sites include: CH₂═CH—R_{f1}—CH═CH₂ wherein R_{f1} may be a perfluoroalkylene of 1 to 8 carbon atoms.

The amount of coagent used generally will be at least 0.1, 0.5, or even 1 part by weight per 100 parts of fluorinated polymer; and at most 2, 3, 5, or even 10 parts by weight per 100 parts of fluorinated polymer.

For the purpose of, for example, enhancing the strength or imparting the functionality, conventional adjuvants, such as, for example, acid acceptors, fillers, process aids, or colorants may be added to the curable composition.

For example, acid acceptors may be used to facilitate the cure and thermal stability of the composition. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors are preferably used in amount raging from about 1 to about 20 parts per 100 parts by weight of the fluorinated polymer.

Fillers are often less expensive materials than fluoropolymers, and may be used to bulk up the composition and/or improve performance, such as durability, shrink resistance, etc. Exemplary fillers include: an organic or inorganic filler such as clay, silica (SiO₂), alumina, iron red, talc, diatomaceous earth, barium sulfate, wollastonite (CaSiO₃), calcium carbonate (CaCO₃), calcium fluoride, titanium oxide, iron oxide and carbon black fillers, a polytetrafluoroethylene powder, PFA (TFE/perfluorovinyl ether copolymer) powder, an electrically conductive filler, a heat-dissipating filler, and the like may be added as an optional component to the composition. Those skilled in the art are capable of selecting specific fillers at required amounts to achieve desired physical characteristics in the cured compound. In one embodiment, the composition comprises at least 1, 2, 5, 10, or even 15% by weight of a filler versus the weight of the composition and at most 30, 40, 50, or even 60% by weight of a filler versus the weight of the composition.

In embodiment, the composition comprises a filler that inhibits shrink of the elastomeric composition during thermal treatment. Such fillers can include talc, diatomaceous earth, and/or silica.

Process aides may be added to the composition to aide in the processing of the curable composition by, for example, decreasing the shear viscosity of the composition or the overall viscosity of the composition. Exemplary process aides include, polyethylene (such as that available under the trade designation “A-C 1702” from Honeywell International Inc., Morris Plains, N.J.), stearates (such as zinc stearate, and that available under the trade designation “AFLUX 54” available from Lanxess Chemical Co., Cologne, Germany), waxes (such as canauba wax), organosilicones (such as that available under the trade designation “STRUKTOL WS 280” from Schill+Seilacher “Struktol” GmbH, Hamburg, Germany), fatty acid esters (such as that available under the trade designation “STRUKTOL WB 222” and “STUKTOL HT 290” from Schill+Seilacher “Struktol” GmbH), siloxane elastomers (such as those available under the trade designation “3M DYNAMAR RA 5300”, 3M Co. St. Paul, Minn.), and plasticizers (such as dioctylphthalate and dibutylsebicate). In one embodiment, these processing aides are volatilized during thermal cure. Exemplary commercial process aides available include “SUPRMIX PLASTHALL DBS” from Hallstar, Chicago, Ill., “STRUKTOL WS 280” and “STRUKTOL WB 222” from Schill+Seilacher “Struktol” GmbH, and ARMEEN 18D from Akzo Nobel, Chicago, Ill. In one embodiment, these aides can lead to reduced bonding of the fluorinated polymer with the casing. In one embodiment, the millable composition comprises less than 0.5, 0.3, 0.1, or even no parts of a process aide per 100 parts of the fluorinated polymer.

The fluorinated polymer is mixed with the peroxide, optional co-agent, and filler along with optional conventional adjuvants to form the millable composition. The method for mixing include, for example, kneading with use of a twin roll for rubber, a pressure kneader or a Banbury mixer.

Following mixing, the millable composition is extruded into an assembly, such as that shown in FIG. 3, comprising casing 31 with mandrel 34.

The casing typically comprises metal, such as steel, steel alloys (including carbon steel or stainless), aluminum, aluminum alloys, nickel, nickel alloys, copper, copper alloys, beryllium copper, beryllium copper alloys, and combinations thereof. The casing is typically elongated having a length substantially greater than its width. In one embodiment, the casing has a length of at least 1, 6, 12, 24, or even 36 inches (at least 2.5, 15, 30, 60, or even 91 centimeters); and at most 15, 20, 25, 30, or even 50 feet (at most 4.6, 6, 7.6, 9, or even 15 meter). In one embodiment, the casing has an aspect ratio (outer diameter of casing versus length of casing) of less than 0.05, 0.03, or even 0.02. In one embodiment, the casing is a cylinder, having an interior and exterior wall. In one embodiment, the casing is a tube having corners along the length of the tube, such as a box, also having interior and exterior walls.

The mandrel is positioned within the casing. In one embodiment, the mandrel is centrally located down the longitudinal axis of the casing. The outer surface of mandrel may comprise a pattern of projections along its sides. The mandrel is a temporary mold, which is used to form the interior sidewall of the assembly. In one embodiment, the mandrel has a round shaft with a projecting helical structure. In one embodiment, the mandrel has a round shaft with a projecting double helical structure. In one embodiment, the mandrel is a cylinder having no projections. The mandrel may be made of any material as long as it suitable for the process (e.g., does not interact with the fluorinated polymeric composition and can withstand the heat treatment. Exemplary materials include plastics, and metals such as steel, steel alloys, aluminum, aluminum alloys, nickel, nickel alloys, copper, copper alloys, beryllium copper, beryllium copper alloys, and combinations thereof.

In one embodiment, a bonding agent is positioned along the interior wall of the casing. The bonding agent will, upon heat treatment, react with the casing and the fluorinated polymer composition to bind the fluorinated polymer to the casing surface. Exemplary bonding agents can include reactive silanes including: vinyl silanes (such as 3-aminopropyl triethyoxysilane or vinyl ethoxy silane); reactive amines including vinyl amines; polyimides, and/or other bonding agents known in the art to bond fluoropolymers to metals. Exemplary bonding agents include those available under the trade designation “LORD CHEMLOK 5150”, “LORD CHEMLOK 8116” both available from Lord Corp, Cary, N.C.; “MEGUM 3290-1” and “MEGUM W 3295” both available from Dow Chemical Co., Midland, Mich.; and “CILBOND 30/31”, “CILBOND 33A/33B”, “CILBOND 65 W” available from CTS Coating Technologies, Gloucestershire, UK. Typically, the bonding agent is coated along the interior wall of the casing and then the millable composition is extruded into the mold (comprising the casing and the mandrel). Typically, the bond agent is coated to a thickness of no more than 100, 500, or even 1,000 nanometers.

After filling the length of the mold with the millable composition, the piece is heated to cure the fluorinated polymeric composition and bond the fluorinated polymer to the interior wall of the casing. In one embodiment, heating is conducted at a temperature of about 120-220° C., or even about 140-200° C., for a period of about 8 hours to about 36 hours. Typically, heating is done in an autoclave with a pressure of about 100-1,000 kPa.

In one embodiment, the mandrel may be removed after heat treatment to form the finished good.

In one embodiment, the finished good is a stator, comprising a casing, with a fluorinated polymeric material bonded along the interior wall of the casing. An exemplary stator is shown in FIG. 4, wherein fluorinated polymeric material 42 is bonded to casing 41 along the interior wall 41a of the casing. The fluorinated polymeric material has an open core running longitudinally over the length of the article. Shown in FIG. 4 is a double helical opening, which if examined through the cross-section, would comprise four lobes. However, stators comprising 2 or more lobes are envisioned, such as comprising 2, 4, 6, 8, or more lobes, which may helically twist along the length of the article.

The cured fluorinated polymeric material is an elastomeric material, meaning that the cured composition has an elongation of greater than 100%.

In one embodiment, the finished article has a wall thickness for the fluoropolymeric material of at least 0.5, 1, or even 2 inches (i.e., at least about 1.3, 2.5, or even 5 cm) and at most 4, 5, or even 6 inches (i.e., at most about 10, 12, or even 15 cm). In one embodiment, when the finished article has a length of less than 3 inches, the finished article has a wall thickness for the fluoropolymeric material of at least 0.125, 0.25, or even 0.5 inches (i.e., at least about 0.3, 0.6, or even 1.3 cm).

In one embodiment, the finished article has an aspect ratio (outer diameter of the article versus length of article) of less than 0.05, 0.03, or even 0.02.

In one embodiment, the compounded composition used to create the articles of the present disclosure has a shear viscosity of less than 1500, 1000, or even 500 Pas at 100° C. and a shear rate of 100 s as measured per the Shear Viscosity Test Method disclosed herein.

In one embodiment, the cured fluorinated polymer of the present disclosure has a shrink of less than 5.0, 4.0, 3.5 or even 3.0% as measured by the Shrink Test Method disclosed herein.

In one embodiment, cured fluorinated polymer of the present disclosure has an elongation at break of at least 150% as measured by the Tensile Test Method disclosed herein.

In one embodiment, the articles of the present disclosure have tensile strength of at least 1500, or even 2000 pounds per square inch (psi) as measured by the Tensile Test Method disclosed herein.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used in this section: mL=milliliters, g=grams, lb=pounds, MPa=mega Pascals, min=minutes, h=hours, ° C.=degrees Celsius, and ° F.=degrees Fahrenheit. Abbreviations for materials used in this section, as well as descriptions of the materials, are provided in Table 1.

TABLE 1

| Material | Details |
|---|---|
| Fluorinated polymer 1 (F1) | Described in prep example 1 |
| Fluorinated polymer 2 (F2) | A partially fluorinated raw gum comprising a dipolymer |
| | derived from about 40% of HFP and 60% of VDF by |
| | weight with 0.7% of iodine by weight, 66 wt % fluorine |
| | content, and Mooney viscosity |
| | [ML1 + 10 @100° C.] of 3.5. |
| Fluorinated polymer 3 (F3) | Described in prep example 3 |
| Fluorinated polymer 4 (F4) | Described in prep example 2 |
| Fluorinated polymer 5 (F5) | A partially fluorinated gum comprising a dipolymer derived |
| | from about 39.4% of HFP and 60.6% of VDF by weight |
| | with 65.9 wt % fluorine content and further comprises a |
| | curative, wherein the dipolymer does not comprise any cure |
| | sites and the gum has a Mooney viscosity [ML1 + 10 |
| | @100° C.] of 17. |
| carbon black | Carbon black commercially available from Cancarb Ltd, |
| | Medicine Hat, AB, Canada under the trade designation |
| | “THERMAX N990 ULTRA PURE”. |
| TAIC DLC | Triallyl-isocyanurate DLC 72% active commercially |
| | available Harwick Standard Distribution Corp, Akron, OH |
| Peroxide | 2,5-dimethyl-2,5-di(t-butylperoxy)-hexane, about 50% |
| | active on an inert carrier, available under the trade |
| | designation “VAROX DBPH-50” from Vanderbilt |
| | Chemicals, LLC., Norwalk, CT. |
| Ca(OH)2 | Calcium hydroxide |
| MgO | Magnesium Oxide |
| TALC | Commercially available from Hallstar Co., Chicago, IL |
| Emulsifier | An aqueous solution comprising 30% by weight of |
| | CF₃OCF₂CF₂CF₂OCHFCF₂CO₂NH₄ is the ammonium salt |
| | of the compound prepared as in “Preparation of |
| | Compound 11” in U.S. Pat. No. 7,671,112 and 1.5% |
| | by weight of a fully-fluorinated compound sold under |
| | the trade designation “3M FLUOROINERT ELECTRONIC |
| | LIQUID FC-70” from 3M Co. St. Paul, MN |
| APS | Ammonium persulfate, available from Sigma-Aldrich |
| | Company |
| Diatomaceous Earth | Available under the trade designation “CELITE 350” |
| | from Imerys Minerals Ltd, Cornwall, UK. |
| 1,4- | Commercially available from Tosoh Corp., |
| Diiodooctafluorobutane | Grove City, OH. |
| Potassium phosphate | Available from Sigma-Aldrich Company |
| Magnesium chloride | Available from Sigma-Aldrich Company |

### Preparative Example 1 (PE-1)

A 40 liter reactor was charged with 22500 g of deionized water and heated to 80° C. The agitator rate was then brought to 350 rpm, followed by additions of 40 g of potassium phosphate, 140 g of 1,4 Diiodooctafluorobutane, and 20 g of APS. 2500 g of deionized water was used to flush the reactants into the reactor. Vacuum was broken with HFP. Immediately following this addition, the reactor was pressured with a HFP and VDF ratio of 0.88 and a TFE/VDF ratio of 1.0 until the reactor reached a pressure of 1.5 MPa. Once at pressure, monomer ratios of HFP/VDF was changed to 1.24 and the ratio of TFE/VDF was changed to 0.73. The reaction was run until 30% solids. The latex was then coagulated using a 1.25% magnesium chloride solution in deionized water, and oven dried at 130° C. for 32 h.

### Preparative Example 2 (PE-2)

A 40 liter reactor was charged with 22500 g water, 330 g emulsifier, and 60 g 1,4 diiodooctafluorobutane. The reactor was evacuated, the vacuum was broken and the reactor was pressurized with nitrogen to 0.17 MPa. This vacuum and pressurization was repeated three times. After removing oxygen, the reactor was heated to 71.1° C. and pressurized to 0.57 MPa with HFP. The reactor was then pressurized to 1.19 MPa with VDF, and bringing the reactor pressure to 1.52 MPa with TFE. The reactor was agitated at 350 rpm, and the reaction was initiated with addition of 10 g APS dissolved in 500 g deionized water. As the reactor pressure dropped due to monomer consumption in the polymerization reaction, HFP, TFE, and VDF werecontinuously fed to the reactor to maintain the pressure at 1.52 MPa. The ratio of HFP/VDF was 0.52 by weight and the ratio of TFE/VDF was 1.22 by weight. After 77 minutes the monomer feeds were discontinued and the reactor was cooled. The resulting dispersion had a solid content of 25.3%. The latex was then coagulated using a 1.25% magnesium chloride solution in deionized water, and oven dried at 130° C. for 32 h.

### Preparative Example 3 (PE-3)

The polymer sample was prepared and tested as in Preparative Example 1 except the monomer ratio, once at pressure, of HFP and VDF was 0.42 by weight and the ratio of TFE and VDF was 0.67 by weight.

Shown in Table 1 are the compositions of the polymer used for the various examples and comparative examples given in parts per 100 parts polymer. Shown in

TABLE 1

| | Example or Counter Example | | | | | |
|---|---|---|---|---|---|---|
| | EX-1 | EX-2 | CE-1 | CE-2 | CE-3 | CE-4 |
| | Polymer Used | | | | | |
| | F1 | F1 | F2 | F3 | F4 | F5 |
| Polymer | 100 | 100 | 100 | 100 | 100 | 100 |
| N990 | 10 | 10 | 10 | 10 | 10 | 10 |
| TAIC DLC 72% | 2 | 2 | 2 | 2 | 2 | |
| DBPH-50 | 2 | 2 | 2 | 2 | 2 | |
| Celite 350 | 15 | | | | | |
| TALC | | 15 | 15 | 15 | 15 | 15 |
| Ca(OH)₂ | | | | | | 6 |
| MgO | | | | | | 3 |

Rheology Test Method

Cure rheology tests were carried out using uncured, compounded samples using a rheometer marketed under the trade designation PPA 2000 by Alpha technologies, Akron, Ohio, in accordance with ASTM D 5289-93a at 160° C., no pre-heat, 12 min elapsed time, and a 0.5 degree arc. Both the minimum torque (M_{L}) and highest torque attained during a specified period of time when no plateau or maximum torque (M_{H}) was obtained were measured. Also measured were the time for the torque to increase 2 units above M_{L} (t_{S}2), the time for the torque to reach a value equal to M_{L}+0.1 (M_{H}−M_{L}), (t'10), the time for the torque to reach a value equal to M_{L}+0.5 (M_{H}−M_{L}), (t'50), and the time for the torque to reach M_{L}+0.9 (M_{H}−M_{L}), (t'90).

Tensile Test Method

Tensile data was gathered from the press cured samples cut to Die D specifications at room temperature in accordance with ASTM 412-06A.

Shrink Test Method

Shrink was calculated by first measuring the mold for positions A₀-H₀. The rectangular mold had dimensions of approximately 7.80 cm (width)×15.6 cm (length). The molded was divided into 4 equal distances across the length and width of the mold where A₀=distance from the starting edge to the first quarter as measured along the width; B₀=distance from the starting edge to the second quarter (or half) as measured along the width; C₀=distance from the starting edge to the third quarter as measured along the width; D₀=distance from the starting edge to the opposing edge as measured along the width; E₀=distance from the starting edge to the first quarter as measured along the length; F₀=distance from the starting edge to the second quarter (or half) as measured along the length; G₀=distance from the starting edge to the third quarter as measured along the length; and F₀=distance from the starting edge to the opposing edge as measured along the length. The polymeric material was placed in the mold and the press cured sheet (7.80 cm×15.6 cm cured for 20 mins at 160° C.) was allowed to cool for at least 30 minutes. The molded polymeric material was divided into 4 equal distances across the length and width of the positions A_{F}-H_{F} were measured, where A_{F}=distance from the starting edge to the first quarter as measured along the width; B_{F}=distance from the starting edge to the second quarter (or half) as measured along the width; C_{F}=distance from the starting edge to the third quarter as measured along the width; D_{F}=distance from the starting edge to the opposing edge as measured along the width; E_{F}=distance from the starting edge to the first quarter as measured along the length; F_{F}=distance from the starting edge to the second quarter (or half) as measured along the length; G_{F}=distance from the starting edge to the third quarter as measured along the length; and F_{F}=distance from the starting edge to the opposing edge as measured along the length. The final shrink value was determined by averaging the following four data points (D_{F}−D₀)*100; (C_{F}−A_{F})/(C₀−A₀)*100; (H_{F}−H₀)*100; and (G_{F}−E_{F})/(G₀−E₀)*100.

Shear Viscosity Test Method

Shear viscosity was determined by running compounded samples through a Rosand capillary rheometer (available from Malvern Instruments Ltd, Worchestershire, UK) with a shear rate of 100 s⁻¹ at 100° C. equipped with a 1 mm die.

Shown in Table 2 below are the results from physical testing of the examples and comparative examples.

TABLE 2

| | Example or Counter Example | | | | | | | | | | | |
|---|---|---|---|---|---|---|---|---|---|---|---|---|
| | EX-1 | | EX-2 | | CE-1 | | CE-2 | | CE-3 | | CE-4 | |
| | Polymer Used | | | | | | | | | | | |
| | F1 | | F1 | | F2 | | F3 | | F4 | | F5 | |
| M_{L}, in-lb (Nm) | 0 | | 0 | | 0 | | 0.3 | (0) | 0.5 | (0.1) | 0.2 | (0) |
| M_{H}, in-lb (Nm) | 15.3 | (1.7) | 13.6 | (1.5) | 5.5 | (0.6) | 20.8 | (2.8) | 24.9 | (2.8) | 12 | (1.4) |
| Δ torque in-lb (Nm) | 15.3 | (1.7) | 13.6 | (1.5) | 5.5 | (0.6) | 20.5 | (2.3) | 24.4 | (2.8) | 11.8 | (1.3) |

| | | | | | | |
|---|---|---|---|---|---|---|
| tₛ2, min | 1.2 | 1.7 | 6.0 | 1.3 | 1.0 | 7.4 |
| t′50, min | 2.3 | 2.9 | 7.3 | 2.3 | 2.3 | 8.5 |
| t′90, min | 6.1 | 7.9 | 14.2 | 5.3 | 5.5 | 14.1 |
| tan δ M_{L} | 5.3 | 5.7 | 6.5 | 2.2 | 2.3 | 2.4 |
| tan δ M_{H} | 0.1 | 0.1 | 0.2 | 0.1 | 0.0 | 0.1 |

Physical Properties: Press Cure 20 mins @160° C.

| Tensile | 1679 | (11.6) | 1724 | (11.9) | 970 | (6.7) | 2694 | (18.6) | 1536 | (10.6) | 1367 | (9.4) |
|---|---|---|---|---|---|---|---|---|---|---|---|---|
| Strength, psi (MPa) | | | | | | | | | | | | |
| Elongation @ break % | 345 | | 362 | | 464 | | 446 | | 255 | | 318 | |
| 50% | 446 | (3.1) | 540 | (3.7) | 234 | (1.6) | 483 | (3.3) | 752 | (5.2) | 374 | (2.6) |
| Modulus, psi (MPa) | | | | | | | | | | | | |
| 100% | 598 | (4.1) | 668 | (4.6) | 311 | (2.1) | 637 | (4.4) | 880 | (6.1) | 609 | (4.2) |
| Modulus, psi (MPa) | | | | | | | | | | | | |

| | | | | | | |
|---|---|---|---|---|---|---|
| Hardness, Shore A ASTM | 79 | 80 | 57 | 78 | 91 | 70 |
| D2240-05 | | | | | | |

Shrink Data

| | | | | | | |
|---|---|---|---|---|---|---|
| % Change | 2.2 | 1.6 | 1.8 | 2.0 | 2.5 | 2.2 |

Shear Viscosity (Pa · s) @ shear rate

| | | | | | | |
|---|---|---|---|---|---|---|
| 100 s⁻¹ | 447 | 345 | 407 | 1326 | 1864 | 1216 |

As shown in Table 2, EX-1 and EX-2 maintained adequate tensile strength and elongation, while having low shear viscosity.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

What is claimed is:

1. A method of making an assembly, the method comprising:
obtaining a millable composition comprising (a) a random fluorinated polymer, the random fluorinated polymer comprising repeating divalent monomeric units derived from TFE, HFP and VDF and further comprising 0.1 to 1% by weight iodine, wherein the random fluorinated polymer has an MFI greater than 5 g/10 min at 265° C. and 5 kg; (b) a filler, and (c) a peroxide, wherein the millable composition has a melting point less than 125° C.;
obtaining a casing open at both ends and positioning a mandrel running longitudinally therethrough;
extruding the millable composition into a space between an interior wall of the casing and the mandrel to form a shaped composition;
treating the shaped composition with heat to bond the shaped composition to the interior wall of the casing to form an assembly.

2. The method of claim 1, further comprising coating an interior wall of the casing with a bonding agent prior to extruding.

3. The method of claim 2, wherein the bonding agent is selected from at least one of a reactive vinyl silane, a reactive amine, and polyimide.

4. The method of claim 1, wherein the mandrel is removed after treating with heat.

5. The method of claim 1, wherein the mandrel comprises a round shaft with a projecting helical structure.

6. The method of claim 1, wherein the casing is an elongated tube.

7. The method of claim 1, wherein the casing is metal.

8. The method of claim 1, wherein the casing has an aspect ratio of less than 0.4.

9. The method of claim 1, wherein the assembly has a length of at least 15 cm.

10. The method of claim 1, wherein the assembly has a length of at least 6 meters.

11. The method of claim 1, wherein the peroxide is at least one of 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)₃-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, and O,O′-1,3-propanediyl OO,OO′-bis(1,1-dimethylethyl) ester.

12. The method of claim 1, wherein the millable composition further comprises a co-agent.

13. The method of claim 1, wherein the assembly is a stator.

14. The method of claim 1, wherein the amount of TFE, HFP and VDF is 20-60 wt % TFE; 10-30 wt % HFP; and 15-60 VDF.

15. The method of claim 1, wherein the random fluorinated polymer comprises repeating divalent monomeric units further derived from at least one of a perfluorovinyl ether monomer, and a perfluoroallyl ether monomer.

16. The method of claim 1, wherein the random fluorinated polymer comprises repeating divalent monomeric units further derived from a cure site monomer.

17. An article comprising: a casing and a shaped fluorinated polymer bonded thereto, the shaped fluorinated polymer derived from (a) a fluorinated elastomeric gum comprising repeating divalent monomeric units, the repeating divalent monomeric units derived from TFE, HFP and VDF and comprising 0.1 to 1% by weight iodine, (b) a filler, and (c) a peroxide, wherein the fluorinated elastomeric gum has an MFI greater than 5 g/10 min at 265° C. and 5 kg; and wherein the shaped fluorinated elastomeric polymer is elongated and includes an open core with lobes.

18. The article of claim 17, wherein the article has an aspect ratio of less than 0.4.

19. The article of claim 17, wherein the article is at least 20 feet in length.

20. The article of claim 17, wherein the shaped fluorinated polymer comprises at least 2 lobes.
